(19) United States
(12) Patent Application Publication
(10) Pub. No.: US 2023/0389562 A1
(43) Pub. Date: Dec. 7, 2023

(54) METHOD AND APPARATUS FOR PRODUCING FREEZE-DRIED RICE

(71) Applicant: lace foods Co., Ltd., Sakai-shi (JP)

(72) Inventors: Yoshihiro SAKO, Izumi-shi (JP); Mitsuhiro SATO, Izumi-shi (JP)

(73) Assignee: lace foods Co., Ltd., Sakai-shi (JP)

(21) Appl. No.: 17/833,521

(22) Filed: Jun. 6, 2022

(51) Int. Cl. A23B 9/08; A23L 5/10; A23L 7/10; A23B 9/10

(52) U.S. Cl. CPC A23B 9/08; A23L 5/13; A23L 7/1975; A23B 9/10; A23V 2002/00

(57) ABSTRACT

A method for producing freeze-dried rice according to the present disclosure includes a rice cooking process of obtaining cooked rice by cooking rice with superheated steam, and a freeze-drying process of obtaining freeze-dried rice by freezing the obtained cooked rice and then drying the frozen cooked rice under vacuum. Preferably, in the rice cooking process, the cooked rice is obtained such that a rice cooking increase rate (a ratio of a weight of rice after cooking to a weight of rice before cooking) falls within a range of 260% to 280%. More preferably, in the freeze-drying process, the obtained cooked rice is washed, and then the cooked rice is frozen and dried.

### BACKGROUND OF THE INVENTION

### I. Technical Field

The present invention relates to a method and an apparatus for producing freeze-dried rice which is restored to fresh cooked rice by pouring boiling water.

### 2, Description of the Related Art

Freeze-dried rice that is restored to fresh cooked rice by pouring boiling water is commercially available as instant fresh cooked rice or emergency cooked rice in the related art. In order to produce the freeze-dried rice, after cooked rice is obtained by cooking rice with a pot, freeze-dried rice is generally obtained by freezing the obtained cooked rice and further drying the frozen cooked rice under vacuum (see, for example, “Comparative Example” of JP 61-43983 B).

However, when the inventors of the present application variously attempted to produce freeze-dried rice by the method of the related art, it was almost impossible to obtain the freeze-dried rice which was restored to fresh cooked rice by immersion in boiling water for a practical short time of about 5 minutes and which had texture equivalent to texture of normal fresh cooked rice. That is, in order to restore the cooked rice to the fresh cooked rice for a practical short time, it is necessary to significantly increase a rice cooking increase rate (which is a ratio of a weight of rice after rice cooking to a ratio of a weight of rice before rice cooking, and is also referred to as “rice cooking yield” or “rice restoration rate”) of the cooked rice, whereas it has become clear that there is a problem that texture after restoration is softer than texture of normal fresh cooked rice when the rice cooking increase rate is increased.

### CITATION LIST

### Patent Literature

Patent Literature 1: JP 61-43983 B
Patent Literature 2: JP 6223711 B
Patent Literature 3: JP 3172519 B

### SUMMARY OF THE INVENTION

The inventors of the present application have found through trial and error to solve this problem that it is possible to obtain the freeze-dried rice to be restored to the fresh cooked rice for a practical short time while suppressing the rice cooking increase rate of the cooked rice at a low level by applying rice cooking using superheated steam disclosed in JP 6223711 B and JP 3172519 B by one of the co-applicants of the present application instead of pot cooking of the related art in order to obtain the cooked rice. It has become clear that since the rice cooking increase rate of the cooked rice can be suppressed at the lower level than in the related art, the texture after restoration is not softer than in the related art and more preferable texture is obtained. The present invention has been made by the inventors of the present application through their trial and error, and an object of the present invention is to provide a method and an apparatus for producing freeze-dried rice which is restored to fresh cooked rice by immersion in boiling water for a practical short time, the fresh cooked rice being more excellent in texture than fresh cooked rice restored from freeze-dried rice of the related art.

In order to achieve the above object, a method according to a first aspect of the present invention is a method for producing freeze-dried rice. The method includes a rice cooking process of obtaining cooked rice by cooking rice with superheated steam, and a freeze-drying process of obtaining freeze-dried rice by freezing the obtained cooked rice and thereafter drying the frozen cooked rice under vacuum.

According to this configuration, since the cooked rice is obtained by using the superheated steam instead of pot cooking of the related art, the freeze-dried rice that can be restored to the fresh cooked rice by immersion in boiling water for a practical short time while suppressing the rice cooking increase rate of the cooked rice at the low level is obtained. Since the rice cooking increase rate of the cooked rice can be suppressed at the lower level than in the related art, the texture after restoration is not softer than in the related art, and more preferable texture is obtained.

A method according to a second aspect of the present invention is the method for producing freeze-dried rice according to the first aspect, in which the rice cooking process obtains the cooked rice such that a rice cooking increase rate falls in a range from 260% to 280%.

According to this configuration, since the rice cooking increase rate is optimized, texture equivalent to texture of normal cooked rice is obtained.

A method according to a third aspect of the present invention is the method for producing freeze-dried rice according to the first or second aspect, in which the freeze-drying process washes the obtained cooked rice, and thereafter freezes and dries the cooked rice.

According to this configuration, amylose adhering to a surface of the cooked rice is washed away by washing the cooked rice, and thus, rice grains are less likely to form lumps.

A method according to a fourth aspect of the present invention is the method for producing freeze-dried rice according to any one of the first to third aspects, in which the rice cooking process obtains the cooked rice by exposing the rice to the superheated steam while transferring the rice by a belt conveyor.

According to this configuration, the uniformity of the obtained cooked rice is improved.

A method according to a fifth aspect of the present invention is the method for producing freeze-dried rice according to the fourth aspect, in which the rice cooking process stirs the rice by using stirrers arranged at intervals along the belt conveyor in a procedure of transferring the rice by the belt conveyor.

According to this configuration, the uniformity of the obtained cooked rice is further improved. Since the stirrers are arranged at intervals, damage to rice grains is small.

A method according to a sixth aspect of the present invention is the method for producing freeze-dried rice according to the fourth or fifth aspect, in which the rice cooking process sprinkles the rice with water by using sprinklers arranged at intervals along the belt conveyor in a procedure of transferring the rice by the belt conveyor.

According to this configuration, even when amylose adheres to the surfaces of rice grains, the rice grains are easily washed away with water, so that cooked rice with less adhesive components is obtained. Since the sprinklers are arranged at intervals, heating of rice grains with superheated steam is not hindered.

An apparatus according to a seventh aspect of the present invention is an apparatus for producing freeze-dried rice. The apparatus includes an apparatus for executing the rice cooking process and the freeze-drying process included in the production method according to any one of the first to sixth aspects, and thereby produces the freeze-dried rice.

According to this configuration, the production method according to each aspect of the present invention is executed, and thus, the freeze-dried rice can be produced,

As described above, according to the present invention, the method and the apparatus for producing freeze-dried rice, which is restored to fresh cooked rice by immersion in boiling water for a practical short time, the fresh cooked rice being more excellent in texture than fresh cooked rice restored from freeze-dried rice of the related art, are realized.

Objects, features, aspects, and advantages of the present invention will become more apparent from the following detailed description and the accompanying drawings.

### BRIEF DESCRIPTION OF THE DRAWINGS

FIGS. 1A to 1H are process charts illustrating processes of a method for producing freeze-dried rice according to an embodiment of the present invention;

FIG. 2 is a graph representing results of demonstration experiments, and shows methods of Examples; and

FIG. 3 is a graph showing results of demonstration experiments, and shows methods of Comparative Examples.

### DETAILED DESCRIPTION

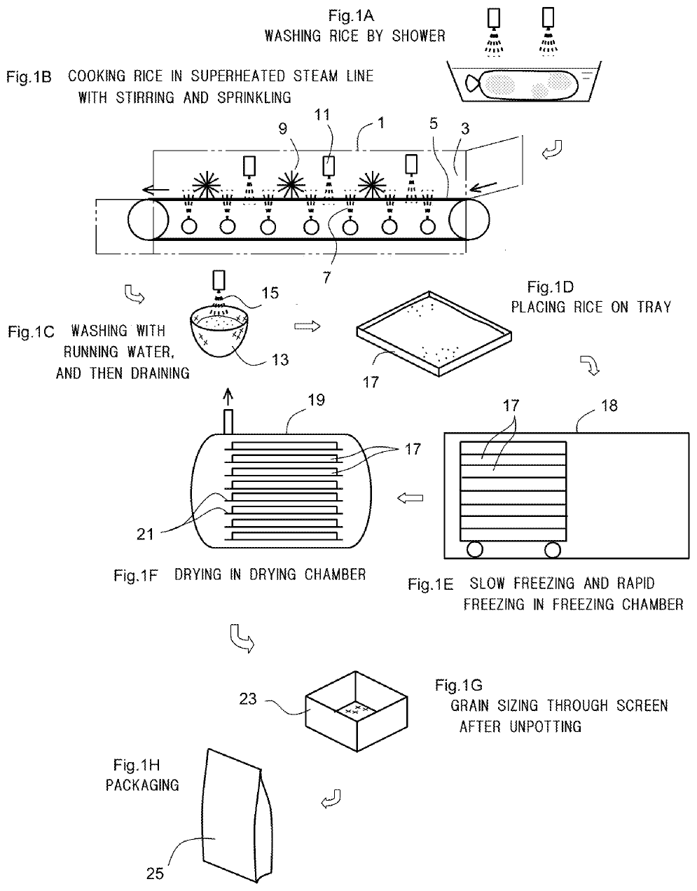

FIGS. 1A to 1H are process charts illustrating processes of a method for producing freeze-dried rice according to an embodiment of the present invention. This production method includes a rice cooking process of obtaining cooked rice by cooking rice with superheated steam, and a freeze-drying process of obtaining freeze-dried rice by freezing the obtained cooked rice and then drying the frozen rice under vacuum. Accordingly, it is possible to obtain freeze-dried rice that is to be restored to fresh cooked rice by immersion in boiling water for a practical short time, the fresh cooked rice being more excellent in texture than fresh cooked rice restored from freeze-dried rice of the related art.

More specifically, in this production method, first, the rice is washed with a shower (see FIG. 1A), and is then put into a line (superheated steam line) 3 of a continuous steam rice cooking system 1 (see FIG. 1B). Washing is performed by placing the rice in a net bag and kneading the rice with the shower. In the superheated steam line 3, superheated steam 7 is blown out from below in a procedure of conveying the put rice at a slow speed by a metal mesh-like conveyor 5, and the rice is heated through the conveyor 5. Stirrers 9 that occasionally stir the rice on the conveyor 5 and sprinklers 11 that occasionally sprinkle water onto the rice on the conveyor 5 from above are provided in the line 3. The stirrers 9 are arranged at intervals along the conveyor 5 to suppress damage to rice grains. The sprinklers 11 are also arranged at intervals along the conveyor 5 not to disturb the heating of the rice grains by the superheated steam 7.

A temperature of the superheated steam is set to, for example, 105° C. to 125° C. A time length from the time when the rice is put to the time when the rice comes out as the cooked rice is set at, for example, about 30 minutes to about 60 minutes. The superheated steam means steam at a high temperature exceeding 100° C. When the steam comes into contact with the surface of the rice, the steam changes into water droplets, and at this time, the rice is heated by applying condensation heat having a large amount of heat. As shown by results of demonstration experiments to be described later, it is most desirable that a rice cooking increase rate of the cooked rice coming out of the line 3 be set to 260% to 280% (that is, moisture absorbed to 100 g of rice by rice cooking is 160 g to 180 g). The rice cooking increase rate can be adjusted in multiple stages, That is, in accordance with the quality of the cooked rice to be obtained, the rice cooking increase rate can be adjusted by the temperature and amount of water sprinkled from the sprinklers 11, a speed of the conveyor 5 through which the put rice is conveyed, the amount and temperature of the superheated steam 7 blown from below the conveyor 5, and the like.

The cooked rice coming out of the line is washed with running water (see FIG. 1C). The cooked rice coming out of the line 3 is quickly washed and is simultaneously cooled such that the rice grains do not stick to each other due to amylose adhering to the surface of the cooked rice or remaining heat. As an example, washing is performed for 60 seconds by putting 2 kg of cooked rice into a round basket 13 and exposing the cooked rice to the running water 15 at to 20° C. The significance of washing the cooked rice is considered as follows. Amylose adheres to the surface of the cooked rice. This is because, among amylose and amylopectin constituting starch, amylose easily comes out on the surface unlike amylopectin. The cooked rice can be single-grain rice by washing away the amylose on the surface, and the remaining heat can be simultaneously cooled. As a result, the rice grains can be prevented from forming lumps. After cooling and washing, draining is performed. Draining is performed, for example, for about seconds.

The cooked rice after draining is filled on a tray 17 (see FIG. 1D). For one tray, as an example, 5 kg of cooked rice is filled.

Subsequently, a large number of trays 17 filled with the cooked rice are put into a freezing chamber 18 (see FIG. 1E). The cooked rice is frozen in a state where the trays 17 are loaded on a carriage. Freezing is performed by slow freezing at first, and is followed by rapid freezing. Slow freezing is performed, for example, by freezing the cooked rice at minus 8° C. to minus 10° C. for 15 hours or more. The slow freezing is performed in order to smoothly restore the freeze-dried rice finally obtained. The subsequent rapid freezing is performed by freezing the cooked rice at minus 20° C. or less, for example, for 24 hours.

When rapid freezing is completed, the trays 17 are taken out from the freezing chamber 18 together with the carriage and are put into a drying chamber 19 (see FIG. 1F). The frozen rice put into the drying chamber 19 is dried. Shelves 21 that hold the trays 17 with intervals between the trays are provided in the drying chamber 19. A thermometer for measuring a shelf temperature is installed on the shelf 21 (not illustrated). The drying chamber 19 is a kind of vacuum chamber with a temperature control function that can control an internal temperature and advances drying by setting the inside to a vacuum state.

The drying process in the drying chamber 19 is performed by raising the temperature and exposing the inside to vacuum. The shelf temperature is maintained at, for example, 70° C. to 80° C. Since a boiling point is below a freezing point under vacuum, moisture undergoes phase transformation (sublimation) from a solid to steam without passing through a liquid. Thus, the shape of the cooked rice remains as it is. The drying process is performed, for example, for 24 hours. As an example, the temperature of the cooked rice finally reaches 50° C. from the sub-zero temperature, and the moisture is reduced to 1% to 3%. As a result, only starch and fibers remain,

The significance of performing slow freezing before rapid freezing is as follows. In the freeze-dried rice that has undergone only rapid freezing, ice crystals formed by freezing water are relatively small. On the other hand, the ice crystals can be enlarged by performing slow freezing first. Accordingly, the surface of the freeze-dried rice becomes rough, and hot water more easily enters. As a result, the obtained freeze-dried rice is more easily restored by boiling water.

The freeze-dried rice which is the cooked rice that has undergone the drying process is taken out (unpotted) of the drying chamber 19, and the grains are sized by a grain sizing process (see FIG. 1G). In the grain sizing process, for example, grains that have passed through a 3-mesh screen (sieve) 23 are selected.

When the grain sizing process is completed, the freeze-dried rice is packed (see FIG. 1H). For example, an aluminum stand pack 25 is filled with 50 grams of freeze-dried rice, and a spoon and a package of deoxidant (not shown) are simultaneously enclosed.

Various apparatuses and utensils illustrated in FIGS. 1A to 1H correspond to examples of elements constituting an embodiment of an apparatus for producing freeze-dried rice according to the present invention.

### EXAMPLES

The inventors of the present application conducted demonstration experiments on the method for producing freeze-dried rice according to the embodiment described above. The results will be described below.

Tables 1 and 2 are tables representing conditions and results of the demonstration experiments. On one hand, Table 1 represents an example according to the above embodiment. On the other hand, Table 2 represents a comparative example in which rice cooking was performed by kneader rice cooking (a kind of pot cooking). The kneader is a cooker that can cook while stirring. Kneader rice cooking means rice cooking using the kneader, and corresponds to a kind of pot cooking. In both Examples and Comparative Examples, the quality of the finished freeze-dried rice is verified while the rice cooking increase rate of the cooked rice is variously changed. In Examples, the rice cooking increase rate is changed in eight ways of Examples (1) to (8). In the comparative examples, the rice cooking increase rate is changed in seven ways of Comparative Examples (1) to (7). In Tables 1 and 2, “Rice restoration rate” represents the rice cooking increase rate. In all Examples, common rice is used as a raw material. The rice is polished into white rice and is non-glutinous rice. In any example, an additive is not added in any one of all the processes of the production method.

TABLE 1
Example data (rice cooking method with superheated steam)

| | \textcircled{1} | \textcircled{2} | \textcircled{3} | \textcircled{4} | \textcircled{5} | \textcircled{6} | \textcircled{7} | \textcircled{8} |
|---|---|---|---|---|---|---|---|---|
| Process | | | | | | | | |
| Superheated | Superheated | Superheated | Superheated | Superheated | Superheated | Superheated | Superheated | Superheated |
| steam | steam | steam | steam | steam | steam | steam | steam | steam |
| ↓ | ↓ | ↓ | ↓ | ↓ | ↓ | ↓ | ↓ | ↓ |
| Washing | Washing | Washing | Washing | Washing | Washing | Washing | Washing | Washing |
| with | with | with | with | with | with | with | with | with |
| running | running | running | running | running | running | running | running | running |
| water | water | water | water | water | water | water | water | water |
| ↓ | ↓ | ↓ | ↓ | ↓ | ↓ | ↓ | ↓ | ↓ |
| Draining | Draining | Draining | Draining | Draining | Draining | Draining | Draining | Draining |
| ↓ | ↓ | ↓ | ↓ | ↓ | ↓ | ↓ | ↓ | ↓ |
| FD | FD | FD | FD | FD | FD | FD | FD | FD |
| Dry FD | 31.00% | 29.50% | 27.00% | 27.20% | 25.90% | 25.40% | 20.20% | 18.80% |
| yield | | | | | | | | |
| Rice | 2.46 times | 2.56 times | 2.73 times | 2.86 times | 2.91 times | 3.00 times | 3.27 times | 3.65 times |
| restoration | | | | | | | | |
| rate | | | | | | | | |
| Sulk | 0.273 | 0.250 | 0.234 | 0.225 | 0.220 | 0.210 | 0.180 | 0.170 |
| specific | | | | | | | | |
| gravity | | | | | | | | |
| (g/cc) | | | | | | | | |
| Quality | | | | | | | | |
| Restoration | Restoration | Restoration | [Optimum] | Restoration | Restoration | Restoration | Restoration | Restoration |
| condition | with boiling | with boiling | Restoration | with boiling | with boiling | with boiling | with boiling | with boiling |
| | water for 5 | water for 5 | with boiling | water for 5 | water for 5 | water for 5 | water for 5 | water for 5 |
| | minutes | minutes | water for 5 | minutes | minutes | minutes | minutes | minutes |
| | | | minutes | | | | | |
| | Restored | Restored | Restored | Restored | Restored | Restored | Restored | Restored |
| | Elasticity | Elasticity | Elasticity | Elasticity | Elasticity | Grainy | Weak in | No |
| | left in | left in | left in | left in | left in | in rice, | graininess | graininess |
| | rice, but | rice, but | rice grains | rice grains, | rice grains, | but soft | in rice, | in rice and |
| | texture left | cores left | | but a little | but watery | | and soft | too soft |
| | hard | in part | | watery | on | | | |
| | | | | in part | surfaces | | | |

TABLE 2
Comparative Example data (kneader rice cooking method)

| Mix | \textcircled{1} | \textcircled{2} | \textcircled{3} | \textcircled{4} | \textcircled{5} | \textcircled{6} | \textcircled{7} |
|---|---|---|---|---|---|---|---|
| Rice | 100 | 100 | 100 | 100 | 100 | 100 | 100 |
| Water | 300 | 350 | 400 | 400 | 400 | 400 | 800 |
| Rice cooking | 95° C. | 95° C. | 95° C. | 95° C. | 95° C. | 95° C. | 95° C. |
| condition | or more | or more | or more | or more | or more | or more | or more |
| | Having | 10 minutes | 10 minutes | 12 minutes | 15 minutes | 20 minutes | 15 minutes |
| | strong | | | | | | |
| | viscosity | | | | | | |
| | and | | | | | | |
| | incapable | | | | | | |
| | of being | | | | | | |
| | heated | | | | | | |
| | and stirred | | | | | | |
| Kneader rice | | Kneader rice | Kneader rice | Kneader rice | Kneader rice | Kneader rice | Kneader rice |
| cooking | | cooking | cooking | cooking | cooking | cooking | cooking |
| ↓ | | ↓ | ↓ | ↓ | ↓ | ↓ | ↓ |
| Washing | | Washing | Washing | Washing | Washing | Washing | Washing |
| with | | with | with | with | with | with | with |
| running | | running | running | running | running | running | running |
| water | | water | water | water | water | water | water |
| ↓ | | ↓ | ↓ | ↓ | ↓ | ↓ | ↓ |
| Draining | | Draining | Draining | Draining | Draining | Draining | Draining |
| ↓ | | ↓ | ↓ | ↓ | ↓ | ↓ | ↓ |
| FD | | FD | FD | FD | FD | FD | FD |
| Dry FD yield | | 21.20% | 23.30% | 20.50% | 17.70% | 18.10% | 17.60% |
| Rice | | 3.35 times | 3.53 times | 3.54 times | 3.63 times | 3.78 times | 3.74 times |
| restoration | | | | | | | |
| rate | | | | | | | |
| Quality | | | | | | | |
| Restoration | | Restoration | Restoration | Restoration | Restoration | Restoration | Restoration |
| condition | | with boiling | with boiling | with boiling | with boiling | with boiling | with boiling |
| | | water for 5 | water for 5 | water for 5 | water for 5 | water for 5 | water for 5 |
| | | minutes | minutes | minutes | minutes | minutes | minutes |
| | | Not restored | Not restored | Not restored | Restored, but no good texture | | |
| | | Having cores | Having cores | Having cores | Soft, but | Soft and | Soft and |
| | | and hard | in part at | in part at | having a | porridge- | porridge- |
| | | | central | central | little | like | like |
| | | | portion | portion | elasticity | | |

In Examples represented in Table 1, rice cooking with superheated steam was performed by setting a temperature of superheated steam at 105° C. to 125° C. and setting a time length from the time when the rice is put to the time when the rice comes out as the cooked rice at about 30 minutes to about 60 minutes. On the other hand, in Comparative Examples represented in Table 2, kneader rice cooking was performed at a temperature of 95° C. or higher.

In any of Examples, detailed conditions of each process after rice cooking are as follows. Washing was performed for 60 seconds by putting 2 kg of cooked rice into the basket 13 (see FIGS. 1A to 1H) and exposing the cooked rice to running water 15 at 1.5° C. to 20° C. Draining after washing was performed for about 30 seconds. Slow freezing was performed by freezing the cooked rice at minus 5° C. to minus 10° C. for 15 hours or more. The subsequent rapid freezing was performed by freezing the cooked rice at minus 20° C. or lower for 24 hours. The drying process was performed for 24 hours while the shelf temperature of the drying chamber 19 was maintained at 50° C. to 80° C.

In Tables 1 and 2, “FD” representing a process means freeze-drying, “Dry Ft) yield” means a weight of rice after freeze drying relative to a weight of rice before freeze drying. In Table 1, “Bulk specific gravity” means weight/volume. In any of Examples, the quality of the finished freeze-dried rice is evaluated by a state of restoration of the freeze-dried rice to the fresh cooked rice after 50 g of freeze-dried rice is poured with 120 cc of boiling water at 90° C. and left for 5 minutes.

As represented in Table 1, in Examples in which the rice was cooked by using the superheated steam, in a wide range in which the rice cooking increase rate was 2.46 times (246%) to 3.65 times (365%), the freeze-dried rice was restored to the fresh cooked rice by immersion in boiling water for 5 minutes. Under the condition that the rice cooking increase rate was 2.56 times, the restored rice grains had elasticity, but the cores remained in a part of the rice grains. Under the condition that the rice cooking increase rate was 2.86 times, slightly soft and watery texture were observed in the restored rice grains. When the rice cooking increase rate was 2.73 times corresponding to the middle thereof, the rice grains do not have the cores and are not soft, and an optimal texture was obtained.

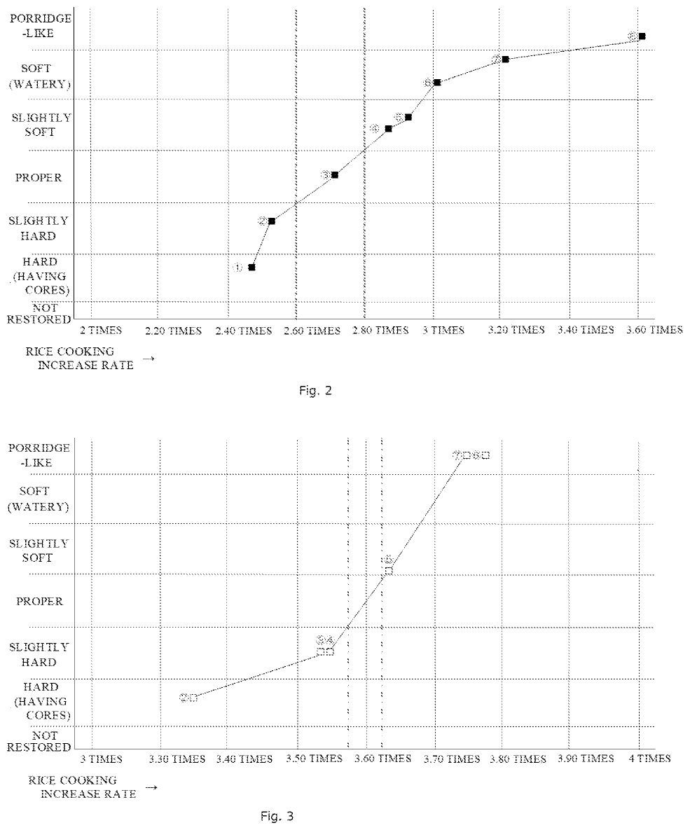

FIG. 2 is a graph representing a relationship between a restoration rate and quality represented in Table 1. Quality on a vertical axis represents texture, that is, sensory evaluation. For example, even in an evaluation of “slightly soft”, the closer to “soft” which is a higher evaluation thereof, the softer the texture is, and the closer to “suitable” which is a lower evaluation, the more suitable the texture is. As represented in the graph of FIG. 2, since texture almost close to proper texture is obtained in both a case where the rice cooking increase rate is 2.56 times and a case where the rice cooking increase rate is 2.86 times, it is understood that the proper texture is obtained in the restored fresh cooked rice in a range of the rice cooking increase rate from 2.60 times (260%) to 2.80 times (280%) (a range sandwiched by dotted lines in the drawing).

On the other hand, as represented in Table 2, in Comparative Examples in which the rice was cooked by the kneader rice cooking, the freeze-dried rice is not restored to the fresh cooked rice under the condition that the rice cooking increase rate was 3.54 times or less. When the rice cooking increase rate was 3.63 times or more, although restoration was performed, the restored fresh cooked rice was soft, and good texture was not obtained. Even when the rice cooking increase rate was 3.63 times which was slightly higher than 3.54 times, only soft texture was obtained although there was a little elasticity.

FIG. 3 is a graph representing a relationship between restoration rate and quality represented in Table 2. As in FIG. 2, in FIG. 3, quality on a vertical axis represents evaluation based on texture. As represented in the graph of FIG. 3, since the texture is out of the proper texture in both a case where the rice cooking increase rate was 3.54 times and a case where the rice cooking increase rate was 3.63 times which were slightly different, there is a possibility that there is no range in which the proper texture that is not soft but is restored to the fresh cooked rice was obtained in the first place. That is, even when the core remains in a central portion, the surroundings thereof are already soft, and when the rice cooking increase rate is increased until the core disappears, the restored cooked rice may have only soft texture. Even if there is a range in which the proper texture is obtained, it will be understood that the range is limited to a narrow range around 3.60 times (360%) (a range sandwiched by dashed dotted lines in the drawing) as shown in FIG. 3. When the proper range is so narrow, it is difficult to adjust the rice cooking increase rate in the production process, and there is a concern that a yield of the product is lowered. That is, production efficiency will be low. It can be said that the method of Examples in Which the rice is cooked by using the superheated steam solves such problems and can produce the freeze-dried rice which is restored to fresh cooked rice excellent in texture with high efficiency.

The cooked rice cooked in a household rice cooker has a rice cooking increase rate of about 210%. However, as shown in Comparative Examples, in the method for producing the freeze-dried rice by using the kneader in the related art, the rice cooking increase rate of the cooked rice is set to 360% or more as described above. Otherwise, as described above, even when hot water is poured into the finished freeze-dried rice, the hot water is not sufficiently absorbed, the cores remain, and the freeze-dried rice is not restored to the fresh cooked rice. In Examples in which the rice is cooked by using the superheated steam, the proper rice cooking increase rate of 260% to 280% is lower than that in the kneader rice cooking in the related art. This indicates that when the rice is cooked with the superheated steam, the finished freeze-dried rice is restored in a practical short time by boiling water even with such an amount of increase in moisture. Since the amount of increase in moisture of the cooked rice is small, when the hot water is poured into the obtained freeze-dried rice and the freeze-dried rice is restored to the cooked rice, the texture is improved as in normal fresh cooked rice with a small amount of moisture.

In general, as the rice cooking increase rate is higher, the freeze-dried rice is more easily restored to the fresh cooked rice when the hot water is poured, and the restored rice is softer. The cause thereof is considered as follows. The rice cooking increase rate is directly related to a ratio of moisture taken into the rice grains by rice cooking. Accordingly, it is considered that the rice cooking increase rate directly corresponds to a space factor of cavities formed in the rice grains when moisture is frozen by freeze drying and is further sublimated. When the boiling water is poured, the poured boiling water fills the cavities and penetrates the rice grains. Thus, it is considered that the higher the rice cooking increase rate is, the higher is a ratio of boiling water penetrating the rice grains, and thus the rice grains are more easily restored and become softer. It is presumed that when the rice is cooked by using the superheated steam, moisture penetrates the rice grains more finely and deeply. Thus, it is considered that the cavities are finely and deeply formed in the rice grains after freeze drying and the rice grains are easily restored by the boiling water even though the rice grains have a low rice cooking increase rate and thus a cavity ratio is low.

As factors that the production method using the superheated steam cooking is more excellent in texture of the freeze-dried rice after restoration than the production method using the kneader cooking, the followings can be further mentioned in addition to the one that the amount of increase in moisture can be set to be low as described above.

(1) The uniformity of the cooked rice is poor in the kneader rice cooking, whereas the uniformity of the cooked rice is good in the superheated steam cooking. In particular, the uniformity is further improved by the belt conveyor type (see the conveyor 5 in FIG. 1B) and the stirring (see the stirrer 9 in FIG. 1B).

(2) In the kneader rice cooking, the rice grains constantly shake during the rice cooking, and the rice grains receive physical friction. Thus, cell walls of the rice grains are broken, and thus, amylose as a glue component comes out of cells and adheres to the surfaces of the rice grains. On the other hand, in the superheated steam cooking, there is no collision between the rice grains, and thus, the cell walls are less broken. Since the amount of amylose leaking out of the rice grains is small, the adhesion of the adhesive component to the surfaces of the rice grains is small.

(3) In the superheated steam cooking, a large amount of heat is applied to rice, and heat is transferred to rice in a short time. This also causes the cell walls to be less likely to break unlike the kneader rice cooking. The small destruction of the cell walls itself contributes to the improvement of the texture.

(4) In the superheated steam cooking, water is sprinkled during heating (see sprinklers 11 in FIG. 1B). Thus, even if amylose adheres to the surfaces of the rice grains, the amylose is easily washed out with water in a procedure of heating, which is one of the causes of less adhesion of the adhesive component.

This application is based on Japanese Patent Application No. 2020-175261 filed on Oct. 19, 2020, the entire contents of which are incorporated herein by reference.

The above description of specific embodiments of the present invention has been presented for the purpose of illustration. They are not intended to be exhaustive or to limit the invention as it is in the form described. It is obvious to those skilled in the art that many modifications and variations are possible in light of the above description.

### REFERENCE MARKS IN THE DRAWINGS

1 continuous steam rice cooking system
3 line (superheated steam line)
5 conveyor
7 superheated steam
9 stirrer
11 sprinkler
13 round basket
15 running water
17 tray
18 freezing chamber
19 drying chamber
21 shelf
23 screen (sieve)
25 aluminum stand pack

1. A method for producing freeze-dried rice, comprising:
obtaining cooked rice by cooking rice with superheated steam; and
obtaining freeze-dried rice by freezing the obtained cooked rice and thereafter drying the frozen cooked rice under vacuum,
wherein the obtained cooked rice is washed after the cooking has been finished and prior to the freezing and drying.

2. The method for producing freeze-dried rice according to claim 1, wherein the cooked rice is obtained such that a rice cooking increase rate falls in a range from 260% to 280%.

3. The method for producing freeze-dried rice according to claim 1, wherein the cooking is performed by exposing the rice to the superheated steam while transferring the rice by a belt conveyor, and the washing is performed after the cooked rice has come out of the belt conveyor.

4. The method for producing freeze-dried rice according to claim 3, wherein the rice is stirred by stirrers arranged at intervals along the belt conveyor while the rice is transferred by the belt conveyor.

5. The method for producing freeze-dried rice according to claim 3, wherein the rice is sprinkled with water by sprinklers arranged at intervals along the belt conveyor while the rice is transferred by the belt conveyor.

6. The method for producing freeze-dried rice according to claim 2, wherein the cooking is performed by exposing the rice to the superheated steam while transferring the rice by a belt conveyor, and the washing is performed after the cooked rice has come out of the belt conveyor.

7. The method for producing freeze-dried rice according to claim 4, wherein the rice is sprinkled with water by sprinklers arranged at intervals along the belt conveyor while the rice is transferred by the belt conveyor.
